(19) United States
(12) Patent Application Publication
(10) Pub. No.: US 2003/0120552 A1
(43) Pub. Date: Jun. 26, 2003

(54) System and method for facilitating sale of a network-enabled device

(76) Inventor: Chet Butikofer, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/029,486

(22) Filed: Dec. 21, 2001

(51) Int. Cl. G06F 17/60

(52) U.S. Cl. 705/26

(57) ABSTRACT

The present disclosure relates to a system and method for facilitating sale of a network-enabled device. In one arrangement, the system and method pertain to receiving indication of an intent to sell the network-enabled device, and automatically transmitting a request to a network-based sales service to post a sale notice that offers the network-enabled device for sale on a network.

### FIELD OF THE INVENTION

The present disclosure relates to a system and method for facilitating sale of a network-enabled device. More particularly, the disclosure relates to a system and method with which a network-enabled device can automatically facilitate posting of a sales notice on a network such as the Internet.

### BACKGROUND OF THE INVENTION

With the rapidity with which new electronic devices are introduced in the market, persons frequently replace their old electronic devices with new ones as they become available. When the user decides to, for instance, upgrade to a new electronic device, the question often then is what to do with the old device. In that there is a market for used electronic devices, it makes sense to attempt to sell the old device to another. Unfortunately, however, the time and/or expense associated with advertising the old device frequently outweighs the benefit of actually selling the device. Accordingly, persons often forego this process and keep the old device, even though it is left unused.

In view of the above, it can be appreciated that it would be desirable to have a system and method that facilitates the sales process for used network-enabled devices so as to make this process more convenient and simple for the user.

### SUMMARY OF THE INVENTION

The present disclosure relates to a system and method for facilitating sale of a network-enabled device. In one arrangement, the system and method pertain to receiving indication of an intent to sell the network-enabled device, and automatically transmitting a request to a network-based sales service to post a sale notice that offers the network-enabled device for sale.

The present disclosure also relates to a device sale manager stored on a computer-readable medium, the manager being executable by a network-enabled device. In one arrangement, the device sale manager comprises logic configured to receive an indication of an intent to sell the network-enabled device, and logic configured to facilitate transmission of a request to a network-based sales service to post a sale notice that offers the network-enabled device for sale.

In addition, the present disclosure relates to a network-enabled device. In one arrangement, the network-enabled device comprises a processing device, and memory including a device sale manager, the sale manager including logic configured to receive an indication of an intent to sell the network-enabled device, and logic configured to facilitate transmission of a request to a network-based sales service to post a sale notice that offers the network-enabled device for sale.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a schematic view of an example system in which the invention can be implemented.

FIG. 2 is a schematic view of a network-enabled device shown in FIG. 1.

FIG. 3 is a flow diagram that illustrates an example of the manner in which the invention can be used to facilitate sale of a network-enabled device.

FIGS. 4A and 4B provide a flow diagram that illustrates operation of a device sale manager identified in FIG. 2 in facilitating the sale of a network-enabled device.

### DETAILED DESCRIPTION

Disclosed herein is a system and method for facilitating sale of a network-enabled device. To facilitate description of the system and method, an example system in which the invention can be implemented will first be discussed with reference to the figures. Although this system is described in detail, it will be appreciated that this system is provided for purposes of illustration only and that various modifications are feasible without departing from the inventive concept. After the example system has been described, examples of operation of the system will be provided to explain the manners in which sales can be facilitated.

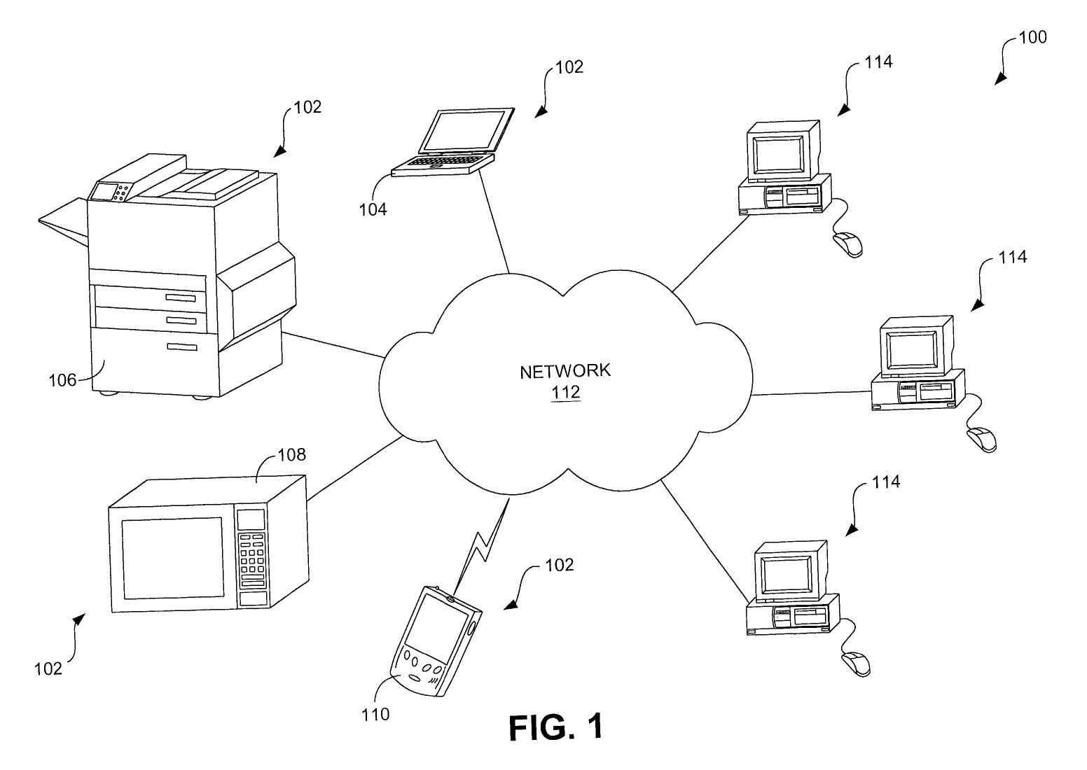

Referring now in more detail to the drawings, in which like numerals indicate corresponding parts throughout the several views, FIG. 1 illustrates an example system 100. As indicated in this figure, the system 100 generally comprises one or more network-enabled devices 102. The term “network-enabled device” is used to designate any device, product, appliance, good, etc. that is capable of connecting with a network, such as the Internet, and transmitting and/or receiving data via the network. As shown in FIG. 1, the one or more network-enabled devices 102 can comprise a notebook personal computer (PC) 104, a printer 106, a kitchen appliance 108, and a personal digital assistant 110. Although these few network-enabled devices 102 are explicitly identified, persons having ordinary skill in the art will appreciate that many other types of network-enabled devices may apply. For instance, the network-enabled device can even comprise an item in which computing capability is secondary. For instance, the network-enabled device can comprise an automobile where the automobile includes an on-board computer that is capable of network communications.

As is further indicated in FIG. 1, each of the network-enabled devices 102 can connect to network 112. The network 112 typically comprises one or more sub-networks that are communicatively coupled to each other. By way of example, these networks can include one or more local area networks (LANs) and/or wide area networks (WANs). Indeed, in some embodiments, the network 112 may comprise a set of networks that forms part of the Internet. The connection established between the network-enabled devices 102 and the network 112 can be a direct, physical connection, for instance including a wire or optical fiber, or a wireless connection, for instance facilitated with radio frequency (RF) or infrared (IR) transmissions.

Also identified in FIG. 1 is a plurality of computing devices 114 which represent several of the many potential buyers of the network-based device 102 that is to be offered for sale.

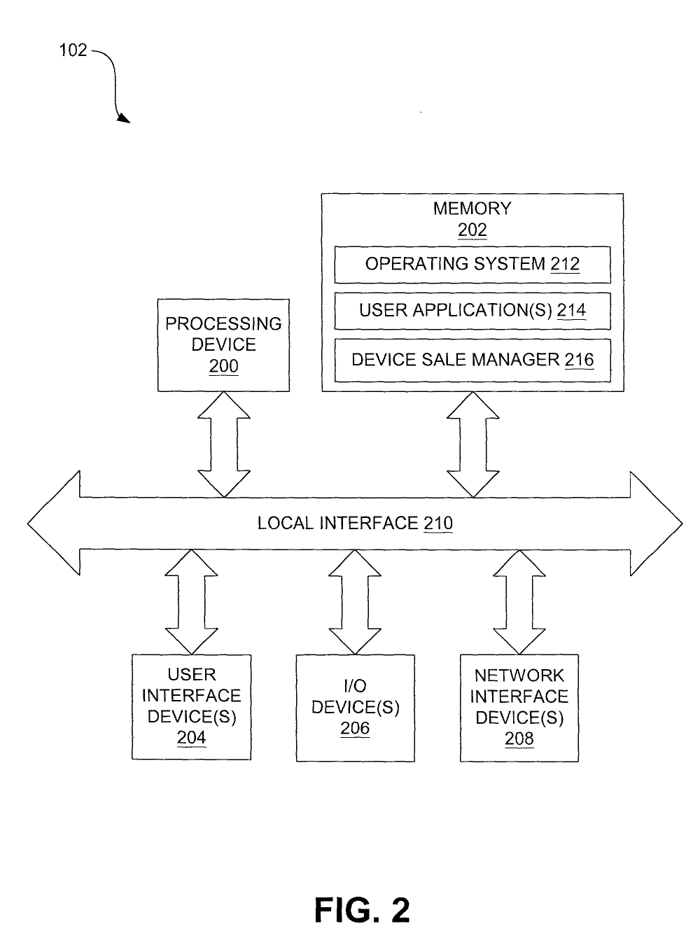

FIG. 2 is a schematic view illustrating an example architecture for the network-enabled devices 102 shown in FIG. 1. As indicated in FIG. 2, each network-enabled device 102 can generally comprise a processing device 200, memory 202, one or more user interface devices 204, one or more input/output (I/O) devices 206, and one or more network interface devices 208, each of which is connected to a local interface 210. The processing device 200 can include any custom made or commercially available processor, a central processing unit (CPU) or an auxiliary processor among several processors associated with the network-enabled device 102, a semiconductor based microprocessor (in the form of a microchip), a macroprocessor, one or more application-specific integrated circuits (ASICs), a plurality of suitably configured digital logic gates, etc. The memory 202 can include any one of a combination of volatile memory elements (e.g., random access memory (RAM, such as DRAM, SRAM, etc.)) and nonvolatile memory elements (e.g., ROM, hard drive, tape, CDROM, etc.).

The one or more user interface devices 204 comprise those components with which the user can interact with the network-enabled device 102. By way of example, these components can comprise a keyboard, a mouse, a display, function keys or buttons, a touch-sensitive screen, etc. With further reference to FIG. 2, the one or more I/O devices 206, where provided, are adapted to facilitate connection of the network-enabled device 102 to another device, such as a peripheral device 102, and may therefore include one or more serial, parallel, small computer system interface (SCSI), universal serial bus (USB), IEEE 1394 (e.g., Firewire™), and/or personal area network (PAN) components. The network interface devices 208 comprise the various components used to transmit and/or receive data over the network 112. By way of example, the network interface devices 210 include a device that can communicate both inputs and outputs, for instance, a modulator/demodulator (e.g., modem), wireless (e.g., RF) transceiver, a telephonic interface, a bridge, a router, network card, etc.

The memory 202 normally comprises some form of operating system 212, one or more user applications 214, and a device sale manager 216. The operating system 212 controls the general computing of the network-enabled device 102 and the execution of other software. In addition, the operating system 212 can provide scheduling, input-output control, data management, memory management, and communication control and related services. The user applications 214 comprise applications that execute on the network-enabled device 102 and which are accessible to the user. For instance, where the network-enabled device 102 comprises a PC or PDA, the applications 214 may include a word processing application, a network browser application, etc. Where the network-enabled device 102 comprises an appliance, the user applications 214 may comprise a programming application that permits the user to program operation of the appliance. Where the network-enabled device 102 comprises an automobile, the user applications 214 may include, for instance, a trip calculator.

Persons having ordinary skill in the art will appreciate that the manner of the user applications 214 depend greatly upon the nature of the underlying network-enabled device 102.

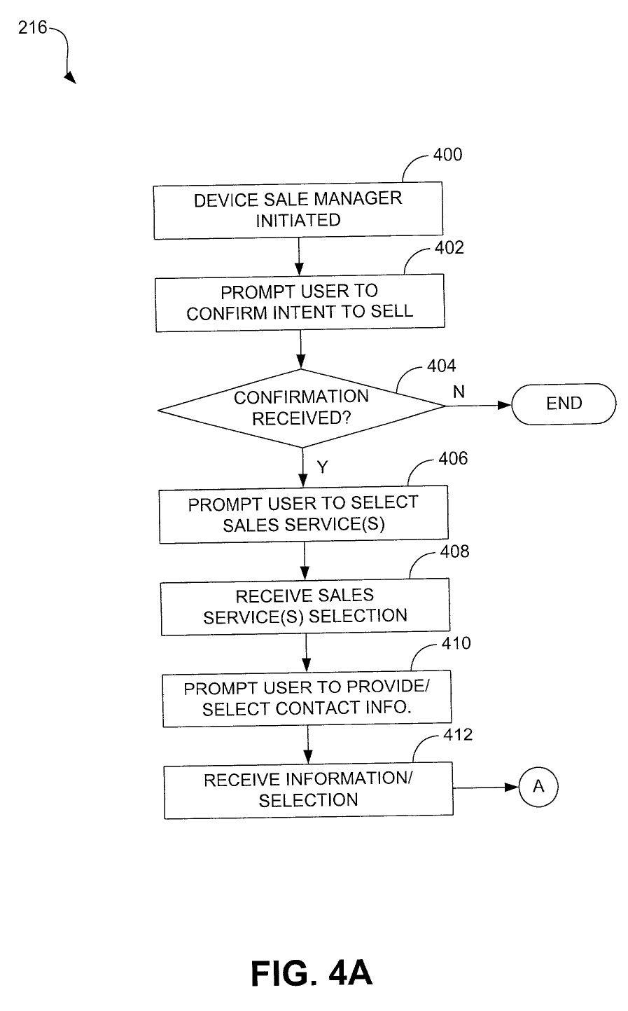

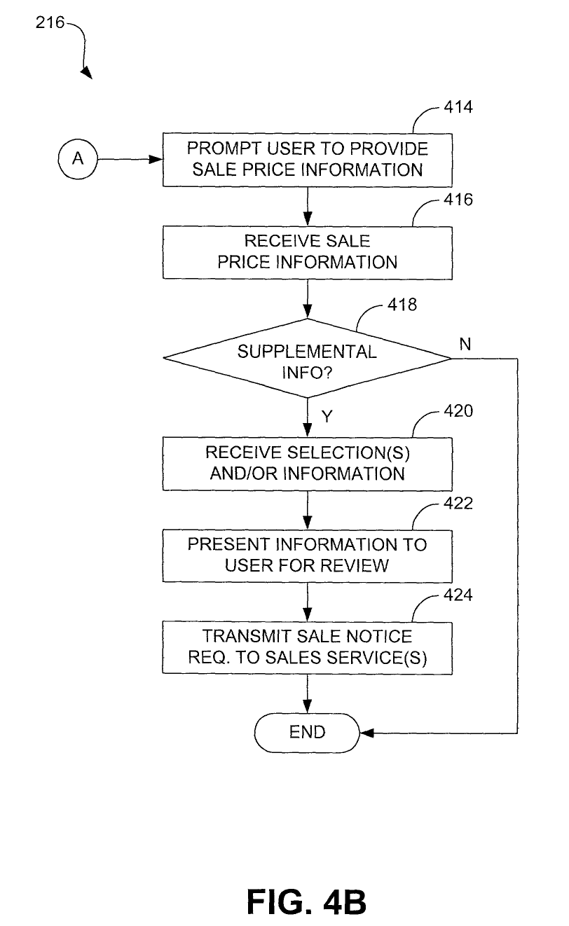

The device sale manager 216 comprises software and/or firmware that is used to facilitate the sale of the network-enabled device 102 at the request of the user. This facilitation can comprise the creation of a sale notice that advertises the network-HP enabled device 102 on one or more sales (e.g., auction) web sites. In some arrangements, the device sale manager 216 is also configured to record and store information concerning use of the network-enabled device 102. The nature of this information may vary depending upon the nature of the network-enabled device 102. For instance, where the network-enabled device 102 comprises a PC or PDA, the manager 216 may record the number of hours the device has been used. Where the network-enabled device 102 comprises an automobile, the manager 216 may record information such as the number of times the automobile has been serviced, the nature of the service visits, the number of miles driven, average speed driven, etc. Persons having ordinary skill in the art will appreciate that many other types of use-related information can be collected by the device sale manager 216. An example of operation of the device sale manager 216 is provided in relation to FIG. 4 below.

Various software and/or firmware programs have been described herein. It is to be understood that these programs can be stored on any computer-readable medium for use by or in connection with any computer-related system or method. In the context of this document, a computer readable medium is an electronic, magnetic, optical, or other physical device or means that can contain or store a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

An example system 100 having been described above, operation of the system will now be discussed. In the discussion that follows, flow diagrams are provided. It is to be understood that any process steps or blocks in these flow diagrams represent modules, segments, or portions of code that include one or more executable instructions for implementing specific logical functions or steps in the process. It will be appreciated that, although particular example process steps are described, alternative implementations are feasible. Moreover, steps may be executed out of order from that shown or discussed, including substantially concurrently or in reverse order, depending on the functionality involved.

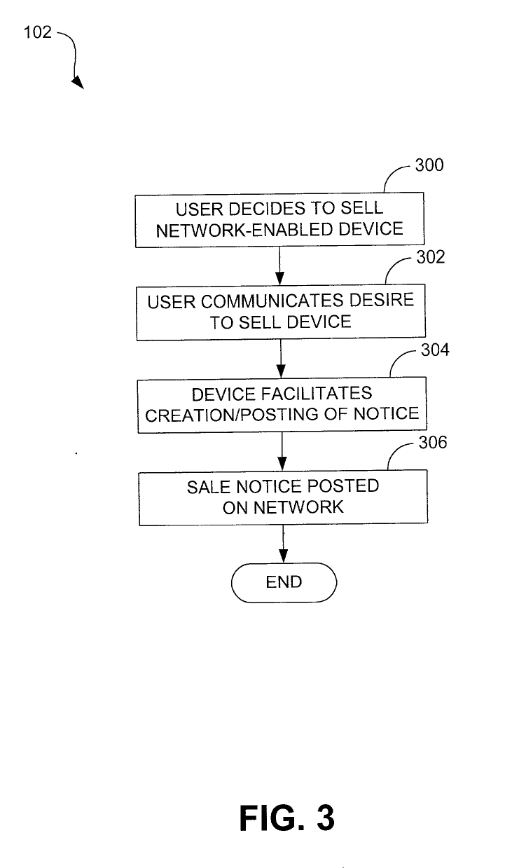

As discussed above, the invention can be used to facilitate the sale of a network-enabled device. Generally speaking, sale is facilitated by taking advantage of the device's network-enablement. Specifically, the device 102 can be used to transmit (e.g., upload) information about itself, a sale price, and the contact information of seller to one or more participating network sites, or can transmit a request to retrieve some or all of this information from a network-accessible location. FIG. 3 provides an overview of an example of this manner of operation.

With reference to block 300 of FIG. 3, the user decides that he or she would like to sell a network-enabled device. Once this decision has been made, the user communicates an intent to sell the network-enabled device to the device, as indicated in block 302. This intent can be communicated using the user interface devices 204. For instance, where the device comprises a PDA, the user can select a “sell me” option from an appropriate drop-down menu that is presented to the user with the device display.

After the user has identified his or her desire to sell the device, the device then automatically facilitates the creation and posting of a sale notice on the network (e.g., Internet), as identified in block 304. By way of example, the sale notice can comprise various general information regarding the network-enabled device (e.g., device specifications, dimensions, functionality, etc.) as well as use-specific information about that particular device (e.g., number of hours or miles the device was used, etc.). The sale notice can further include the asking price as well as contact information of the user (i.e., seller), such as a telephone number, email address, etc.

At this point, the sale notice is posted, for instance by one or more network-based (e.g., web-based) sales services, as indicated in block 306. Once the sale notice is posted, the user can then await offers to purchase the network-enabled device. Accordingly, the network-enabled device can facilitate its own sale so that the user need not expend great deal of time and energy toward making the sale.

FIG. 4A illustrates an example of operation of the device sale manager 216 identified in FIG. 2 in facilitating the sale of the network-enabled device 102. Beginning with block 400, the device sale manager 216 is initiated. As mentioned above, this initiation can occur in response to a communication (i.e., command) from the user that identifies an intent to sell the network-enabled device 102. Again, this intention can be expressed by the selection of an appropriate menu item or by the depression of one or a combination of buttons or keys accessible to the user. To ensure that the user did not accidentally express the intent to sell the network-enabled device 102 (e.g. by accidentally depressing the wrong button), the device sale manager 216 can prompt the user to confirm the expressed intent, as indicated in block 402. With reference to decision element 404, if confirmation is not received, the sale process is canceled and flow is terminated. If confirmation is received, however, flow continues to block 406.

As indicated in block 406, the device sale manager 216 can then prompt the user to select one or more sales services that will be used to offer the device 102 for sale on the network 112. By way of example, these services comprise web sites with which members can post items for sale either in a “classifieds” format or through an auction process. Irrespective the nature of the various services, the services can be presented to the user in one or more lists that, for instance, are shown on the device display. The lists can, for instance, comprise known services that were preprogrammed into device memory 202 at build time. To ensure the most up to date information, the lists can, optionally be periodically updated by a service (e.g., a web-based based service hosted by a web server) associated with the device sale manager 216 via the network 112. Where such an associated service is available, the user may also provide it with various personal information that may facilitate creation and posting of a sale notice. For example, the user may maintain a user profile with the associated service that identifies various contact information for the user, the user's memberships with sales services, etc. In such a scenario, the lists presented by the device sale manager 216 to the user for selection may be limited to sales services of which the user is a member.

Once prompted to select the sale service or services the user wishes to use, the user can enter his or her selection such that it is received by the device sale manager 216, as indicated in block 408. At this point, the user can be prompted to provide and/or select the contact information that will be used in the sale notice that will be created, as indicated in block 410. This contact information typically comprises an email address, telephone number, or other piece of information that a potential buyer can use to contact the user (i.e., seller) to express an interest in purchasing the network-enabled device 102. As noted above, the device sale manager 216 may already possess this information where this information has been provided by an associated network service. Alternatively or in addition, the device sale manager 216 may already have access to the user's contact information by virtue of an owner identification process followed when the network-enabled device 102 was first configured by the user. In either case, the contact information known by the manager 216 can be presented to the user for selection. Where the device sale manager 216 does not possess or have access to all of the user's contact information, the manager can instead prompt the user to enter this information with the user interface devices 204.

Once the user has provided and/or selected the contact information, the information and/or selection is received by the device sale manager 216, as indicated in block 412. With reference to FIG. 4B and block 414, the user then can be prompted to provide sale price information for the network-enabled device 102. Again, this information can be provided by the user by using the user interface devices 204. Where one or more of the sales services that will be used comprise an auction TM service (e.g., eBay™), this information may instead comprise a minimum amount that will be accepted and/or a minimum bid price.

Once the sale price information has been received by the device sale manager 216, as indicated in block 416, it can be determined whether supplemental information is to be provided in the sale notice, as indicated in decision element 418. By way of example, this information may comprise general information concerning device 102 such as a manufacturer's description of the device, specifications for the device, a list of the various functions that can be performed by the device, a photograph of the device, critics' reviews of the device, and the like. Alternatively or in addition, the supplemental information can comprise use-specific information, i.e., information about the particular network-enabled device 102 that identifies the manner in which it has been used. For instance, as mentioned above, this use-specific information may include the number of hours the device has been used, the maintenance that has been performed, number of miles driven (for a vehicle), etc. Again, the nature of the use-specific information is highly dependent upon the nature of the network-enabled device and persons having ordinary skill in the art will appreciate the many variations that are possible.

The supplemental information can also comprise notes or comments that the user wishes to add to the sale notice that may, for example, describe the condition of the network-enabled device 102, identify whether the asking price is negotiable, identify what forms of payment will be accepted, identify additional device features (e.g., software) that the user has added, and so forth. As will be appreciated by persons having ordinary skill in the art, the supplemental information, where to be added, can be made available in a variety of different ways. In the simplest case, this information is entered manually by the user via the user interface devices 204. This method typically is used where the user has notes or comments that he or she would like to add to the notice such as that cited above. In addition or alternatively, the supplemental information can be obtained from device memory 202 or via the network 112. By way of example, general information concerning the device can be accessed from a device manufacturer's web site. In such a case, the address (e.g., uniform resource locator (URL)) of the manufacturer's site can be tagged for provision to the sales service(s) so that the service(s) can either retrieve this information and incorporate it into the sale notice or present the address as a hot link in the sale notice so that potential buyers can access this information, if desired.

If no such supplemental information is to be provided, flow continues down to block 422 described below. If, on the other hand, supplemental information is to be provided, flow continues to block 420 at which the supplemental information selections and/or the supplemental information itself is received by the device sale manager 216. At this point, the user can be presented with the information that will be provided to the sales service(s) for purposes of review and to give him or her the opportunity to make changes as indicated in 422 and, assuming the information is correct and acceptable, the device sale manager 216 can transmit a request to post a sale notice to the one or more sales services, as indicated in block 424. Included with this request is any information that the user has opted to provide including, for instance, the user contact information, asking price, use-specific information, user comments, location of general information, etc. Notably, this information can be presented as raw data that the service can use to create the sale notice, or as a posting-ready sale notice that the services can immediately post for the device sale manager 216.

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for facilitating sale of a network-enabled device, comprising the steps of:
receiving indication of an intent to sell the network-enabled device; and
automatically transmitting a request to a network-based sales service to post a sale notice that offers the network-enabled device for sale on a network.

2. The method of claim 1, wherein the step of receiving indication of an intent to sell comprises receiving the indication with the network-enabled device.

3. The method of claim 1, wherein the step of automatically transmitting a request comprises transmitting information concerning at least one of the network-enabled device and a seller of the device.

4. The method of claim 3, wherein the information includes at least an identification of the network-enabled device, a sale price, and contact information of the seller.

5. The method of claim 3, wherein the information includes use-specific information as to the manner in which the network-enabled device has been used.

6. The method of claim 1, wherein the step of automatically transmitting a request comprises transmitting an address that identifies a location of information pertinent to the network-enabled device.

7. The method of claim 6, wherein the information pertinent to the network-enabled device comprises a description of the device and its features.

8. The method of claim 6, wherein the information pertinent to the network-enabled device comprises an image of the device.

9. The method of claim 1, further comprising the step of prompting the user to select a sales service to post the sale notice.

10. A system for facilitating sale of a network-enabled device, comprising:
means for receiving indication of an intent to sell the network-enabled device; and
means for facilitating transmission of a request to a network-based sales service to post a sale notice that offers the network-enabled device for sale on a network.

11. The system of claim 10, wherein the means for facilitating transmission of a request comprise means for facilitating transmission of information concerning at least one of the network-enabled device and a seller of the device.

12. The system of claim 10, wherein the means for facilitating transmission of a request comprise means for facilitating transmission of an address that identifies a location of information pertinent to the network-enabled device.

13. A device sale manager stored on a computer-readable medium, the manager being executable by a network-enabled device, comprising:
logic configured to receive an indication of an intent to sell the network-enabled device; and
logic configured to facilitate transmission of a request to a network-based sales service to post a sale notice that offers the network-enabled device for sale on a network.

14. The sale manager of claim 13, wherein the logic configured to facilitate transmission of a request comprises logic configured to facilitate transmission of information concerning at least one of the network-enabled device and a seller of the device.

15. The sale manager of claim 14, wherein the information includes at least an identification of the network-enabled device, a sale price, and contact information of the seller.

16. The sale manager of claim 14, wherein the information includes use-specific information as to the manner in which the network-enabled device was used.

17. The sale manager of claim 13, wherein the logic configured to facilitate transmission of a request comprises logic configured to facilitate transmission of an address that identifies a location of information pertinent to the network-enabled device.

18. A network-enabled device, comprising:
a processing device; and
memory including a device sale manager, the sale manager including logic configured to receive an indication of an intent to sell the network-enabled device, and logic configured to facilitate transmission of a request to a network-based sales service to post a sale notice that offers the network-enabled device for sale on a network.

19. The device of claim 18, wherein the logic configured to facilitate transmission of a request comprises logic configured to facilitate transmission of information concerning at least one of the network-enabled device and a seller of the device.

20. The device of claim 19, wherein the information includes at least an identification of the network-enabled device, a sale price, and contact information of the seller.

21. The device of claim 19, wherein the information includes use-specific information as to the manner in which the network-enabled device was used.

22. The device of claim 18, wherein the logic configured to facilitate transmission of a request comprises logic configured to facilitate transmission of an address that identifies a location of information pertinent to the network-enabled device.
